(19) United States
(12) Patent Application Publication
(10) Pub. No.: US 2019/0121536 A1
(43) Pub. Date: Apr. 25, 2019

(54) DISPLAY SYSTEM, DISPLAY DEVICE, TERMINAL DEVICE, AND RECORDING MEDIUM

(71) Applicant: SHARP KABUSHIKI KAISHA, Sakai City (JP)

(72) Inventor: SATOSHI TERADA, Sakai City (JP)

(21) Appl. No.: 16/169,922

(22) Filed: Oct. 24, 2018

(30) Foreign Application Priority Data
Oct. 25, 2017 (JP) 2017-206147

(51) Int. Cl. G06F 3/0488; G06F 3/0484; G06T 11/80

(52) U.S. Cl. CPC G06F 3/04883; G06T 11/80; G06F 3/04842

(57) ABSTRACT

In a terminal device, a partial region of a display screen is identified and one or more objects that are figures and/or characters contained in the identified region are acquired. Aa attribute of the acquired objects that is used when the objects are displayed is determined, and the objects and the attribute of the objects are transmitted to a display device. The display device determines display positions of the received objects, determines a display mode based on the attribute of the received objects, and displays the received objects in the display positions.

### BACKGROUND

### 1. Field

The present disclosure relates to a display system and the like that include a terminal device and a display device connected to the terminal device.

### 2. Description of the Related Art

In recent years, display devices provided with large-sized displays have been becoming widespread and meetings and classes with use of such display devices like electronic white boards have been increasing accordingly. On the other hand, small and medium-sized portable terminals to be possessed by individuals also have been becoming widespread. Accordingly, attempts in which such portable terminals are linked with a shared and large-sized display device installed in a conference room or a classroom have been being made in order to smooth information sharing or exchange of views among users and in order to improve convenience in meetings or classes.

Under these circumstances, embodiments have been disclosed in which each user transmits a memorandum from a tablet-like terminal device the user uses to the display device described above (see Japanese Unexamined Patent Application Publication No. 2010-205137, for instance).

As described above, such display devices used in electric white boards and the like have been increasing in size. Accordingly, there are requests that a memorandum or information is received from terminal devices on sides of one or more users and is displayed on one display screen. Conventionally, however, memoranda to be transmitted are merely displayed but how memoranda are displayed has not been taken into consideration.

Further, above-mentioned Japanese Unexamined Patent Application Publication No. 2010-205137 has problems in that pasting a plurality of memoranda on the display device causes difficulty. in reading due to display of the plurality of memoranda having similar shapes, difficulty in reading due to mixture of memoranda of higher importance and memoranda of lower importance, and low discriminability among writers of the memoranda, because it is impracticable to designate attributes (such as colors, sizes, shapes, importance, and owners) of the pasted memoranda. The problems may interfere with smooth exchange of views and information sharing.

Considering increase in size of display devices, additionally, a method of use has been proposed in which a table type display device is used and input may be carried out on the spot, for instance. Such a method has caused a problem in that providing attributes for a handwritten memorandum involves selection from a menu or icons each. time and thus has caused insufficient usability.

In order to settle the problems described above, it is desirable to provide a display system and the like which receive an attribute together when figures received from the terminal device are displayed and which are thereby capable of appropriately displaying the figure in a display mode based on the attribute.

### SUMMARY

According to an aspect of the disclosure, there is provided a display system including a terminal device and a display device connected to the terminal device. The terminal device includes: a region identification unit that identifies a partial region of a display screen; an acquisition unit that acquires one or more objects which are figures and/or characters contained in the identified region; an attribute determination unit that determines an attribute of the acquired objects which is used when the objects are displayed; and a transmission unit that transmits the objects and the attribute of the objects to the display device. The display device includes: a reception unit that receives the objects and the attribute of the objects from the terminal device; and a display unit that determines display positions of the received objects, determines a display mode based on the attribute of the received objects, and displays the received objects in the display positions in the display mode.

A display device of the disclosure is a display device connectable to a terminal device. The display device includes: a reception unit that receives image data from the terminal device; an acquisition unit that acquires one or more objects which are figures and/or characters from the image data; an attribute determination unit that determines an attribute of the acquired. objects which is used when the objects are displayed; and a display unit that determines display positions of the acquired objects, determines a display mode based on the determined. attribute of the objects; and displays the objects in the display positions in the display mode.

A terminal device of the disclosure is a terminal device connected to a display device that displays objects in a display mode based on an attribute of the objects. The terminal device includes: a region identification unit that identifies a partial region of a display screen; an acquisition unit that acquires one or more objects which are figures and/or characters contained in the identified region; an attribute determination unit that determines the attribute of the acquired objects which is used when the objects are displayed; and a transmission unit that transmits the objects and the attribute of the objects to the display device.

A non-transitory recording medium of the disclosure stores a program causing a computer connectable to a terminal device to implement a reception function of receiving image data from the terminal device, an acquisition. function of acquiring one or more objects that are figures and/or characters from the image data, an attribute determination function of determining an attribute of he acquired objects which is used when the objects are displayed, and a display function of determining display positions of the acquired objects, determining a display mode based on the determined attribute of the objects, and displaying the objects in the display positions in the display mode.

### BRIEF DESCRIPTION OF THE DRAWINGS

FIG. 1 is a diagram illustrating a whole system of a first embodiment;

FIG. 2 is a diagram illustrating configurations of functions of a terminal device in the first embodiment;

FIG. 3 is a diagram illustrating configurations of functions of a display device in the first embodiment;

FIGS. 4A to 4D are diagrams illustrating a summary of processing in the first embodiment;

FIG. 5 is a sequence diagram illustrating flow of processing in the terminal device and the display device in the first embodiment;

FIGS. 6A and 6B are diagrams illustrating an example of an operation in the first embodiment;

FIG. 7 is a diagram illustrating a configuration of a storage unit of the terminal device in a second embodiment;

FIGS. 8A to 8C each illustrate an example of data structure of a label data attribute determination table in embodiments;

FIG. 9 is a sequence diagram illustrating flow of processing in the terminal device and the display device in the second embodiment;

FIGS. 10A and 10B are diagrams illustrating an example of an operation in the second embodiment;

FIG. 11 is a diagram illustrating an example of an operation in a fourth embodiment;

FIG. 12 is a sequence diagram illustrating flow of processing in the terminal device and the display device in a fifth embodiment;

FIG. 13 is a sequence diagram illustrating flow of processing in the terminal device and the display device in a sixth embodiment;

FIG. 14 is a diagram illustrating a whole system of a seventh embodiment;

FIGS. 15A and 15B are diagrams illustrating an example of an operation in an eighth embodiment;

FIG. 16 is a diagram illustrating an example of an operation in a ninth embodiment; and

FIG. 17 is a flow chart illustrating flow of processing in the terminal device in a tenth embodiment.

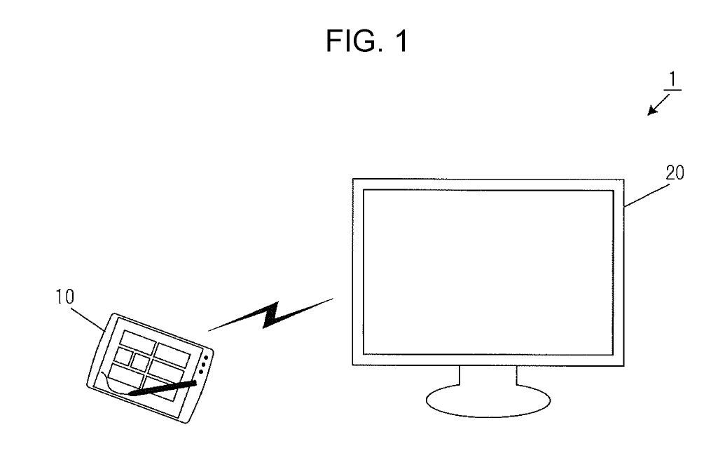

### DESCRIPTION OF THE EMBODIMENTS

Hereinbelow, an image display system 1 in which an image display device of the disclosure is used will be described. Embodiments will be presented below for convenience of description on the disclosure and the scope of the disclosure is not limited to the embodiments below.

[1. First Embodiment]

[1.1 System configuration]

Initially, a first embodiment will be described. The first embodiment, as the image display device, includes a terminal device 10 that is a portable display device such as a tablet and a stationary display device 20 such as a large-sized display.

The terminal device 10 and the display device 20 are configured so as to be connectable to each other. In the embodiment, for instance, the terminal device 10 and the display device 20 are connected so as to be communicable via LAN (wireless LAN or wired LAN). As another method of connection, near field communication such as Bluetooth® and ZigBee® or the like may be used for the connection. That is, the method of the connection does not matter as long as a scheme of the connection enables communication between the terminal device 10 and the display device 20.

As for the terminal device 10 and the display device 20, an object selected and recognized by the terminal device 10 is transmitted to the display device 20 and displayed thereon. An object herein is a unit that may be displayed on one or more display screens and may be any of a figure, a character (character string), an icon, a photograph, and the like, for instance. It is also possible to deal with label data with characters inputted in a figure, label image data, memorandum data as one of objects.

[1.2 Configurations of Functions]

Subsequently, configurations of functions will be described based on the drawings.

[1.2.1 Terminal Device]

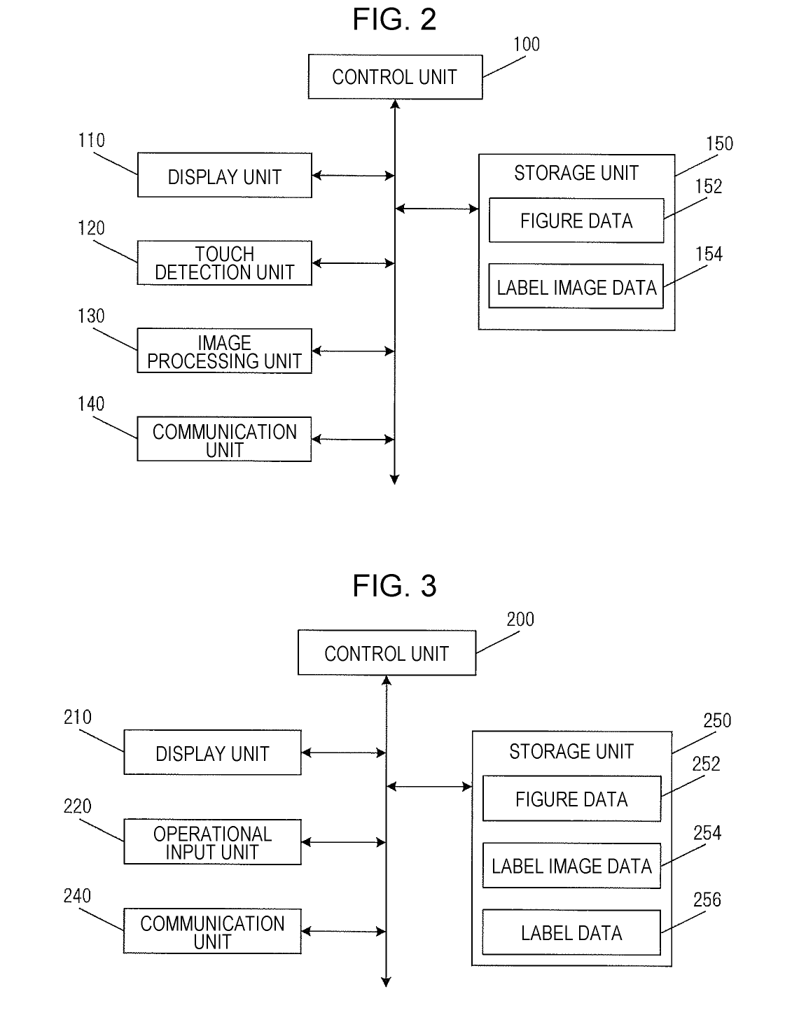

Initially, configurations of functions of the terminal device 10 will be described based on FIG. 2. The terminal device 10 includes a control unit 100, a display unit 110, a touch detection unit 120, an image processing unit 130, a communication unit 140, and a storage unit 150.

The control unit 100 is a functional unit that controls the whole of the terminal device 10. The control unit 100 implements various functions by reading out and executing various programs stored in the storage unit 150 and is made of a central processing unit (CPU) and the like, for instance.

The display unit 110 is a functional unit that displays various contents or the like. The display unit 110 is made of a liquid crystal display (LCD), an organic EL display, or the like, for instance. In the display unit 110, a full image is d splayed all over a display region and figures are displayed in the full image.

The touch detection unit 120 is a functional unit that attains an operational input by detecting a touch operation of a user. The touch detection unit 120 is implemented with use of a touch panel or the like configured integrally with the display unit 110, for instance. As a method of detecting the touch operation, any of capacitive scheme, electromagnetic induction scheme, infrared scheme, and the like may be used as long as such detection can be carried out by the method. The detection may be carried out at one point or a plurality of points.

The touch detection unit 120 inputs a figure as an object, for instance. Specifically, coordinates inputted through a touch by the user are detected and stroke information is stored based on the detected coordinates. Then a figure is recognized based on the stroke information and is stored as figure data 152. The figure is displayed in the full image without modification.

The image processing unit 130 is a functional unit that attains image processing. In the image processing unit 130, various types of image processing such as output of text characters through character recognition based on the figures (handwritten characters) inputted as objects and clipping of an image of an enclosed region from the displayed full image are attained. Besides, processing such as conversion from the stroke information into a figure and conversion from vector data into raster data is carried out.

The image processing unit 130 may be implemented by being stored as programs in the storage unit 150 for each type of processing as appropriate and by being read out and executed as appropriate.

The communication unit 140 is a functional unit through which the terminal device 10 carries out communication. Wireless LAN such as IEEE802.11a/b/g/n or near field communication such as Bluetooth is used for the communication, for instance. Common communication, however, may be carried out therein by LTE communication or the like.

The storage unit 150 is a functional unit in which various programs and various data demanded for operations of the terminal device 10 are stored. The storage unit 150 is made of a semiconductor memory, a hard disk drive (HDD), or the like, for instance.

In addition to the various programs, the figure data 152 and label image data 154 are stored in the storage unit 150.

As the figure data 152, handwritten. characters and handwritten figures based on stroke information stored by handwritten. input (such. as stroke drawing), images inputted from other input devices (such as scanner), and/or images received from other devices and stored are stored.

For instance, the stroke information inputted by handwriting by the user is gathered and thereby stored as a group of figures. In addition, image files such as JPEG data and BMP data from a scanner, a digital camera, image files, and/or the like are stored.

Herein, the term “figure” refers to a concept that encompasses characters and symbols. The characters (symbols) herein include handwritten characters that are characters written by the user with a touch pen, a hand, a mouse, or the like and text characters represented by ASCII, JIS code, Unicode, and the like.

Therefore, text characters (strings) inputted through input units such as keyboard, received text characters (strings), and/or the like are stored as the figure data 152. In this case, for instance, coordinates at which the display region is positioned and coordinates as text regions may be stored together with the text characters (strings).

The figures may each be composed of a character string that is a plurality of characters. In input by handwritting, in other words, strokes inputted in a first time interval are recognized as one handwritten character. Such handwritten characters inputted successively are recognized as a handwritten character string. Such characters and strings are stored as figures in the figure data 152.

Coordinates in the display region of the display unit 110 may be stored as each figure. The figures are each displayed in accordance with the coordinates and are thereby displayed as the full image on the display unit 110.

The label image data 154 is produced by clipping of a portion from the figures by the user. One or more clipped figures may be stored as the label image data or an image clipped from the full image may be stored as the label image data. In cases where the clipped figures are based on vector data or the stroke information, the figures may be clipped after conversion into raster data.

[1.2.2 Display Device]

Subsequently, configurations of functions of the display device 20 will be described based on FIG. 3. As illustrated in FIG. 3, the display device 20 includes a control unit 200, a display unit 210, an operational input unit 220, a communication unit 240, and a storage unit 250.

The control unit 200 is a functional unit that controls the whole of the display device 20. The control unit 200 implements various functions by reading out and executing various programs stored in the storage unit 250 and is made of a central processing unit (CPU) and the like, for instance.

The display unit 210 is a functional unit that displays various contents or the like. The display unit 210 is made of a liquid crystal display (LCD), an organic EL display, or the like, for instance. On the display unit 210, a full image is displayed and figures are displayed in the full image.

The operational input unit 220 is a functional unit that attains an operational input from the user. The operational input unit 220 is implemented as an external keyboard, a mouse, a touch panel configured integrally with the display unit 210, or the like, for instance. As a method of detecting a touch operation, any of capacitive scheme, electromagnetic induction scheme, infrared scheme, and the like may be used as loner as such detection can be carried out by the method. The detection may be carried out at one point or a plurality of points.

The communication unit 240 is a functional unit through which the display device 20 carries out communication. Wireless LAN such as IEEE802.11a/b/g/n or near field communication such as Bluetooth is used for the communication, for instance.

The storage unit 250 is a functional unit in which various programs and various data demanded for operations of the display device 20 are stored. The storage unit 250 is made of a semiconductor memory, a hard disk drive (HDD), or the like, for instance.

In addition to the various programs, figure data 252, label image data 254, and label data 256 are stored in the storage unit 250.

Figures inputted on the display device 20 and figures received from the terminal device 10 are stored as the figure data 252. The stored figure data is displayed on a display region of the display unit 210. The figure data 252 is stored as data of the same type as the figure data 152 and detailed description thereon is therefore omitted.

The label image data 254 is received from the terminal device 10. The label data 256 is generated and stored based on the label image data 254.

Herein, the label data described for the embodiment refers to data that makes it possible to manage the figures or the text strings as a gathering Not only may the label data be simply displayed, but the label data may be displayed. with change in a color thereof and/or with movement thereof in the display region.

The label data may include the figures included in the label image data, an inputted text character string, or text characters converted from handwritten characters. With regard to the label data, it may be made possible to freely perform switching between showing and hiding, pasting, deletion, or the like.

The label data may cumulatively be displayed on other displayed contents (such as figures or images) or may be displayed in isolation. Further, label data expressed herein may be expressed as memorandum data or reminder data, for instance.

Thus the display device 20 may freely display objects such as figures, characters, label data, and contents on the display screen of the display unit 210.

[1.3 Flow of Processing]

Subsequently, flow of processing in the embodiment will be described based on the drawings.

[1.3.1 Summary of Processing]

Initially, generation of the label data in the embodiment will be described. Though the generation in the terminal device 10 will be described herein, the generation may be carried out in the display device 20. The generation may be carried out with division of the processing between the terminal device 10 and the display device 20 as will be described later.

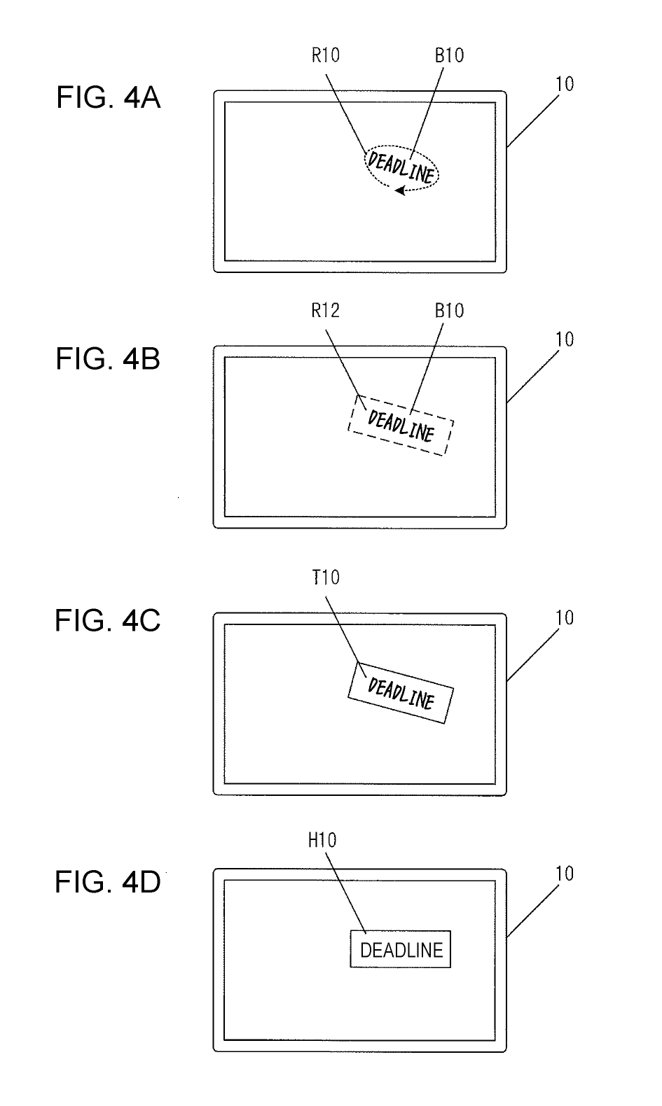

In FIG. 4A, a handwritten character string B10 “DEADLINE” is displayed as one object. The handwritten character string B10 is displayed on the display region of the display unit 110.

The handwritten character string B10 is selected (identified) by the user so as to be enclosed. A region identified by being selected then will be referred to as an enclosed region R10. This stroke is formed so as to enclose the handwritten character string B10 and is therefore recognized as a label selection input. A method of the label selection input may be a method of selection of the enclosed region but may be selection of a label selection input mode or selection by other methods of operations (the number of pens performing enclosure, enclosure by two fingers or three fingers, and the like), for instance.

When the label selection input is recognized, coordinates of the enclosed region are acquired so as to contain the handwritten character string B10. The coordinates of the enclosed region are coordinates of a region R12 in FIG. 4B. The handwritten character string B10 contained in the region R12 is recognized as label image data T10 (FIG. 4C).

Data recognized as the label image data T10 can be transmitted to other devices. FIG. 4D illustrates label data H10 converted. from the label image data T10. In FIG. 4D, the handwritten character string “DEADLINE” has been converted into a text character string “DEADLINE” with conversion into the label data H10. The conversion into the text character string enables addition, editing, and the like of text characters therein. In the label data, attributes of a label (information associated with the label), such as color information, shape, owner, and size, are stored.

In the embodiment, description is given on a case where characters are converted into a text character string when a handwritten character string is selected as an object. However, the handwritten character string may be dealt with as label data containing. figures without modification. Besides, when the selected object is a text character string, the text character string may be selected without modification or may be made figures reversely.

The term “character string” in the embodiment is characters and a character string composed of one or more characters. Characters herein include characters such as numerals, alphabets, symbols, hiragana, katakana, and kanji and include characters used in other foreign languages. Characters may include pictograms depending on cases.

A plurality of objects may be selected by the enclosed region. Then the label data may be displayed for each object (each figure, for instance) or may collectively be displayed as one set of label data. When different types of objects (text strings and images, for instance) are selected, the label data may be displayed for each object or the label selection input may be canceled.

[1.3.2 Sequence Diagram]

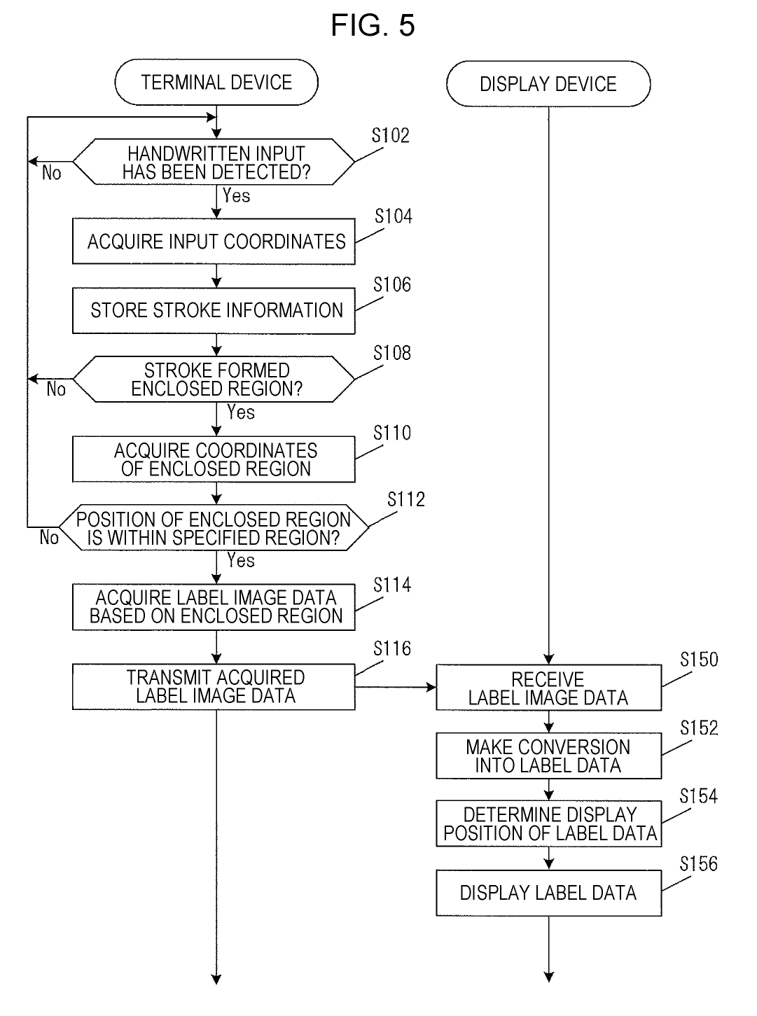

Subsequently, the first embodiment will be described based on FIG. 5. FIG. 5 is a sequence diagram that illustrates processing on a transmitting side that transmits the label image data on which the label data is based and processing on a receiving side that receives the label image data. For the embodiment, description will be given with use of the terminal device 10 as an example of the transmitting side and with use of the display device 20 as an example of the receiving side. Description will be given on a case where an object to be selected as label data is a handwritten character string.

When a handwritten input is detected in the terminal device 10 (step S102; Yes), input coordinates are acquired (step S104). The acquired coordinates are stored as stroke information (step S106).

If any enclosed region has not been formed (step S108; No), the stored stroke information is stored as a figure in the figure data 152. Any of related arts may be used as a method. of storing a handwritten character (string), line segments, or the like, for instance, based on the stroke information.

If such a stroke has formed any enclosed region (step S108; Yes), it is determined that a label selection. input has been provided and coordinates of the enclosed region are acquired (step S110).

As the coordinates of the enclosed region, for instance, coordinates that contain the enclosed region may be extracted. Thee it may be determined whether a position of the enclosed region is a specified position or not (step S112). Specifically, positions where recognition as a label selection input is allowed may be preset in an input-acceptable region and formation of the enclosed region in the positions may be recognized as the label selection input, for instance.

When the processing is carried out in the whole display region, determination in step S112 may be omitted. That is, the processing may be made to proceed to step S114 subsequent to step S110.

Subsequently, the label image data is acquired based on the enclosed region (step S112; Yes→step S114). That is, figures contained in the enclosed region are acquired as the label image data. The acquired label image data is transmitted to the display device 20 that is the receiving side (step S116).

When the display device 20 that is the receiving side receives the label image data (step S150), the display device 20 makes a conversion into the label data based on the label image data (step S152). Specifically, when a handwritten character (string) is included in the label data, processing for conversion into a text character (string) is carried out. The handwritten character string) may be displayed without modification.

Subsequently, a display position of the label data is determined (step S154) and the label data is displayed (step S156).

A plurality of methods are conceivable for determining the display position of the label data. In an initially conceivable method, the position where the label data is to be displayed is predetermined as a default setting and the label data is displayed at the position of the default setting. Alternatively, the display position of the label data may be determined in accordance with the terminal device 10 that has transmitted the label image data. For instance, a screen may be quartered and an area for display thereon may be determined for each terminal.

[1.4 Example of Operation]

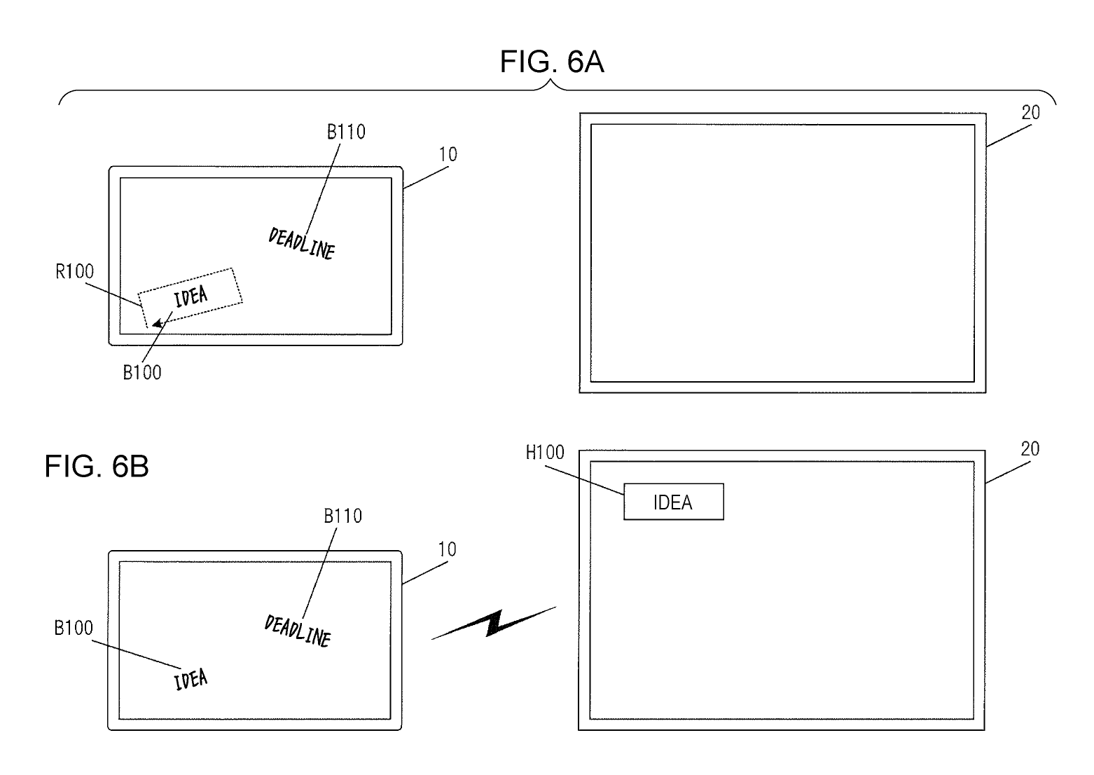

Subsequently, an example of an operation in the embodiment will be described with use of FIGS. 6A and 6B. In FIG. 6A, two figures are displayed on the display region of the terminal device 10. That is, a handwritten character string B100 “IDEA” and a handwritten character string B110 “DEADLINE” are displayed.

Then a rectangle R100 is inputted by the user. This input is provided as an enclosed region and is therefore recognized as a label selection input. The handwritten character string B100 contained in the rectangle R100 is acquired as label image data.

The label image data is transmitted from the terminal device 10 to the display device 20. In FIG. 6B, label data H100 is displayed on the display device 20 based on the label image data. As for the label data H100, the handwritten character string “IDEA” is converted into and displayed as a text character string “IDEA”.

The label data H100 can freely be moved and can be changed in size by the user. The conversion into the text characters as in the embodiment enables editing of the characters (string).

Description is given for the embodiment described above on a case where a handwritten character string that is a figure is selected as an object. However, a text character string displayed as an object may be selected.

In this case, a text character string is transmitted instead of the label image data in step S116. The display device 20 may receive the text character string in step S150, convert. the text character string into the label data, and display the label data.

According to the embodiment, such an operation by the user of enclosing a figure or a text string as a desired object makes it possible to transmit the character string inputted on one image display device and represented by a figure or text to another image display device and to display the character string thereon. The display device may display the character string as label data based on the received object.

This enables the user to carry out an input operation with utilization of a terminal device (an image display device such as a tablet, for instance) the user personally uses, for instance. Even if a plurality of users exist, furthermore, figures can be inputted and transmitted from each terminal device. It becomes possible for the display device to display an input on the terminal device.

[2. Second Embodiment]

A second embodiment will be described. The second embodiment is processing in which an attribute of label data is also recognized in a label selection input based on a method of a selection input and the display mode and the like of label data is changed in the display device in accordance with the attribute. That is, the attribute of the label data may be recognized in accordance with an attribute of a region (enclosed region) subjected to the selection input.

A configuration of a system in the embodiment is the same as that in the first embodiment described above and description on the configuration and the like is therefore omitted. Description on the embodiment will be centered on differences from the first embodiment.

[2.1 Data Configuration]

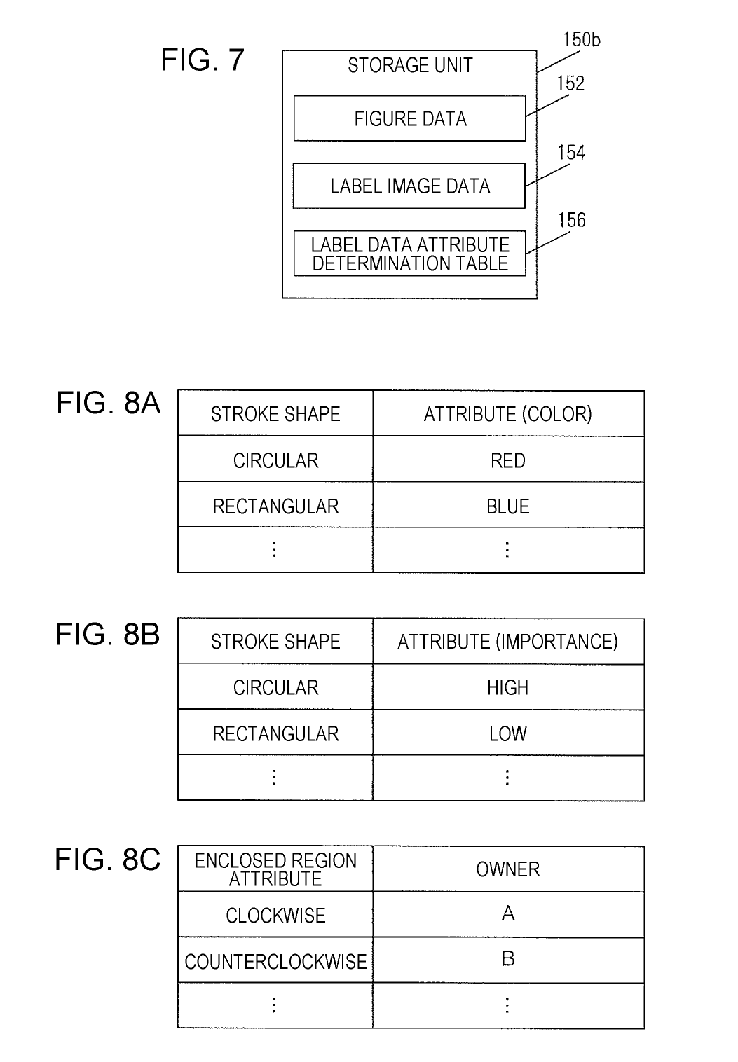

FIG. 7 illustrates the embodiment in which the storage unit 150 of the first embodiment is replaced by a storage unit 1505. As illustrated in FIG. 7, the figure data 152, the label image data 154, and a label data attribute determination table 156 are stored in the storage unit 150b.

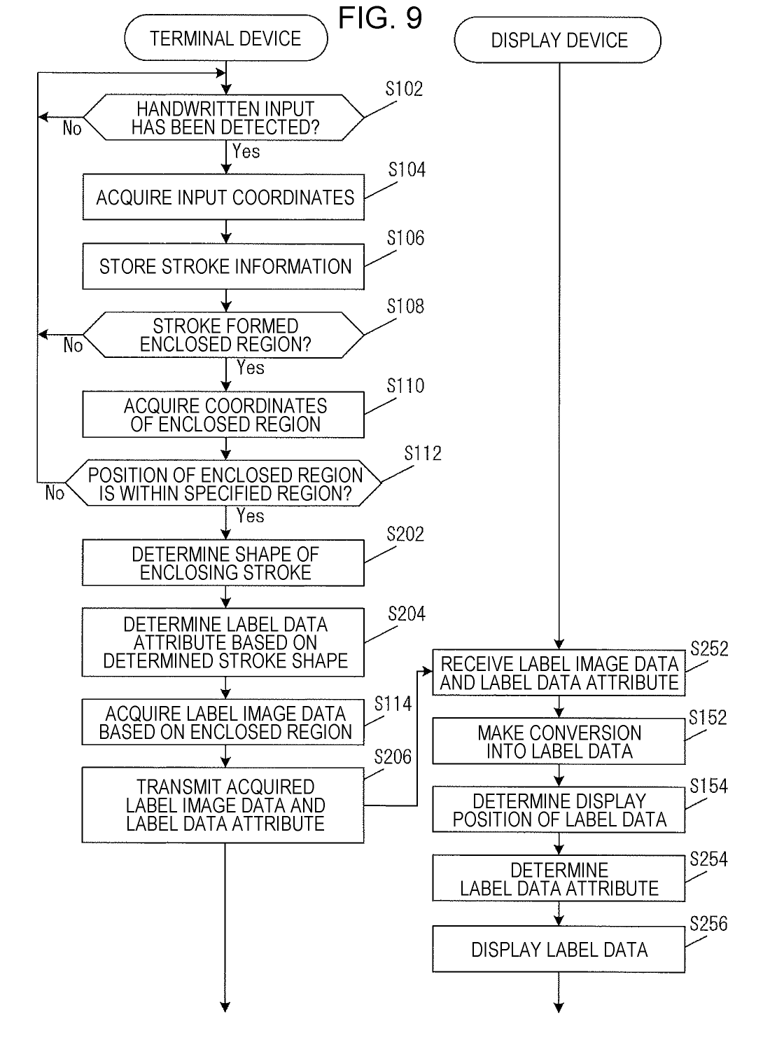

The label data attribute determination table 156 is a table that stores an attribute of the label data in accordance with an attribute of the enclosed region inputted as the label selection input, that is, a stroke (shape) of the enclosed region in the embodiment. As illustrated in FIG. 8A, for instance, the attribute (“RED” as color, for instance) of the label data is stored in association with the stroke shape (“CIRCULAR”, for instance) that is the attribute of the region.

Though description on the embodiment is given with use of color as an example of the attribute of the label data, another display pattern. such as size (font size), font type, and border color of the label data may be stored.

[2.2 Flow of Processing]

Flow of the processing in the embodiment will be described based on a sequence diagram of FIG. 9. The same processing as that of the first embodiment is provided with the same reference characters and description thereon is omitted.

If a detected stroke has formed any enclosed region and is determined as a label selection input (steps S102 to S112; Yes), a shape of the enclosing stroke is determined (step S202) and an attribute of the label data (label data attribute) is determined based on the determined shape of the stroke (step S204). Specifically, the label data attribute is determined based on the label data attribute determination table 156.

Subsequently, the label image data is acquired based on the enclosed region (step S114). After that, the acquired label image data and the label data attribute are transmitted to the display device 20 (step S206). Label additional information including the label data attribute and other information (various types of information such as size of label, for instance) may be transmitted.

The flow of the processing in the embodiment is an example and may be permuted as long as any conflict is not caused in the data. For instance, the label image data may initially be acquired based on the enclosed region and the label data attribute may thereafter be determined (step S114→step S204).

The display device 20 receives the label image data and the label data attribute (step S252). After that, the label image data is converted into the label data and a display position of the label data is determined (step S152→S154).

Then the attribute of the label data is determined based on the received label data attribute (step S254). Subsequently, the label data is displayed based on the determined attribute of the label data (step S256).

Thus the display device 20 may display the label data while changing the display modes of label data based on the label data attribute.

[2.3 Example of Operation]

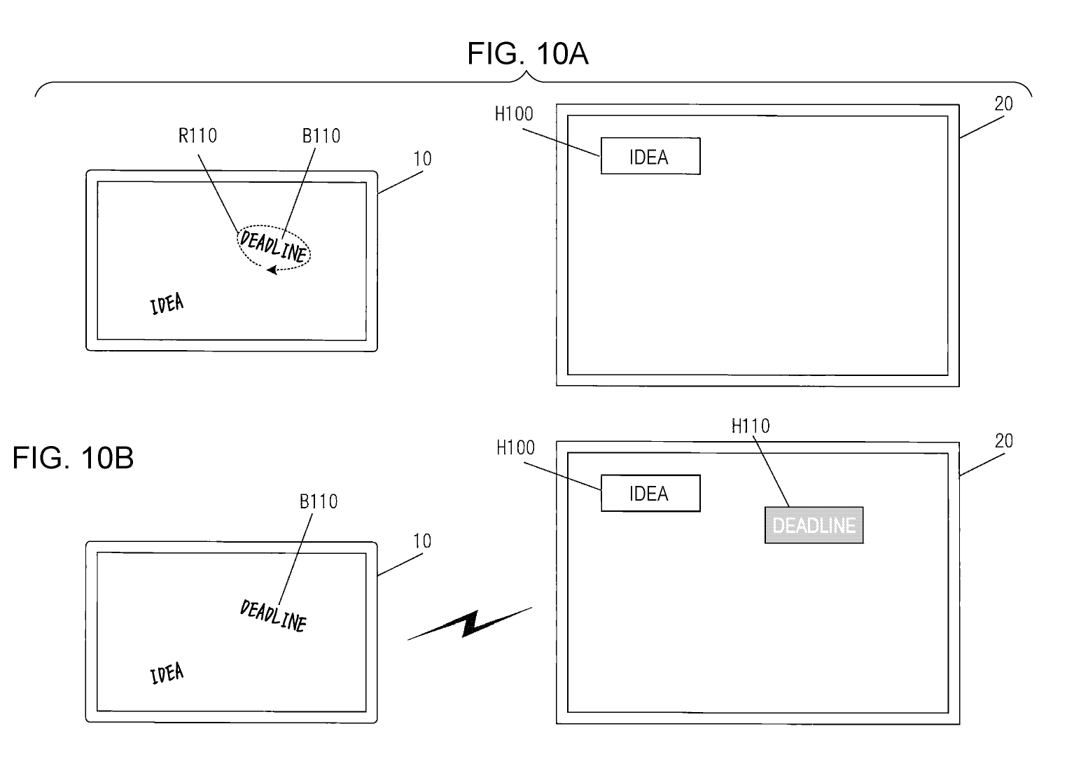

An example of an operation in the second embodiment will be described based on FIGS. 10A and 10B. FIG. 10A is a diagram in which the label data H100 based on the label image data transmitted from the terminal device 10 is displayed on the display device 20 in the first embodiment.

In this state, the handwritten character string B110 “DEADLINE” is selected by an enclosed region R110 specified by a stroke. In this case, label image data containing the handwritten character string B110 is acquired and is transmitted to the display device 20. Then an attribute of label data is additionally transmitted.

In FIG. 10B, the label data H110 converted from the received label image data is displayed on the display device 20. The attributes of the label data differ between a case where the shape of the stroke for the enclosed region is rectangular as in the label data H100 in the first embodiment and a case where the shape of the stroke for the enclosed region is circular as in the label data H110 in the embodiment. That is, the label data H100 and the label data H110 are displayed in different colors.

According to the embodiment, switching of the shape for selection of a figure by the user thus makes it possible to easily switch the attribute of the label data.

The display device 20 may display the label data while switching a plurality of display modes. Therefore, for instance, use is possible in which the label data in each theme is displayed in a different color, and this enables easier understanding for the user.

The user may arbitrarily set the shape of the stroke for the enclosed region that dictates the attribute of the label data and may arbitrarily set the attribute of the label data. Thus a desired attribute (such as color) can be assigned to a desired shape.

The label data attribute determination table 156 may be stored in the display device 20 so that the attribute of the label data may be determined in the display device 20. In this configuration, the label image data and the stroke information for the enclosed region are transmitted from the terminal device 10 to the display device 20. The attribute of the label data may be determined from the transmitted information in the display device 20.

[3. Third Embodiment]

A third embodiment will be described. Though a display attribute such as color is set as the attribute of the label data in the third embodiment, an attribute on contents may be set.

In the third embodiment, the label data attribute determination table 156 of FIG. 8A in the second embodiment is replaced by a label data attribute determination table of FIG. 8B.

That an attribute (“HIGH” as importance, for instance) may be stored in association with the stroke shape. In other words, an attribute on contents, such as importance, may be added as the attribute of the label data. The attribute may be such an attribute as “ERASABLE” and “NON-ERASABLE” or an attribute that represents the owner (Mr. A for the circular shape and Ms. B for the rectangular shape, for instance).

The label data may be d splayed in accordance with the determined attribute of the label data (step S254→S256 in FIG. 9). Thus the label data behaves in accordance with the label data attribute. For instance, in cases where the label data of “HIGH” importance is set. “NON-ERASABLE”, the user is incapable of erasing the label data.

The display device 20 may modify a display mode in accordance with. those attributes. For instance, the data of high importance may be displayed in “red” or with “magnification”.

According to the embodiment, for other than mere display, the display mode of the label data may be changed based on a drawing pattern in accordance with the attribute added to the label data.

[4. Fourth Embodiment]

A fourth embodiment will be described. In the fourth embodiment, an attribute set based on an attribute, other than the shape of the stroke, of the enclosed region is added to the label data.

In the fourth embodiment, the label data attribute determination table 156 of FIG. 8B in the third embodiment is replaced by a label data attribute determination table of FIG. 8C. That is, an attribute (owner “A” in the embodiment) of the label data is associated with an attribute, such as “CLOCKWISE” and “COUNTERCLOCKWISE”, of the enclosed region, for instance.

An attribute “A stroke made by two fingers for the enclosed region has been detected.” or an attribute “The enclosed region has been inputted with another type of operation.” may be set as another attribute of the enclosed region, for instance.

Another attribute such as size, color, and importance may be set as the attribute of the label data, as described above.

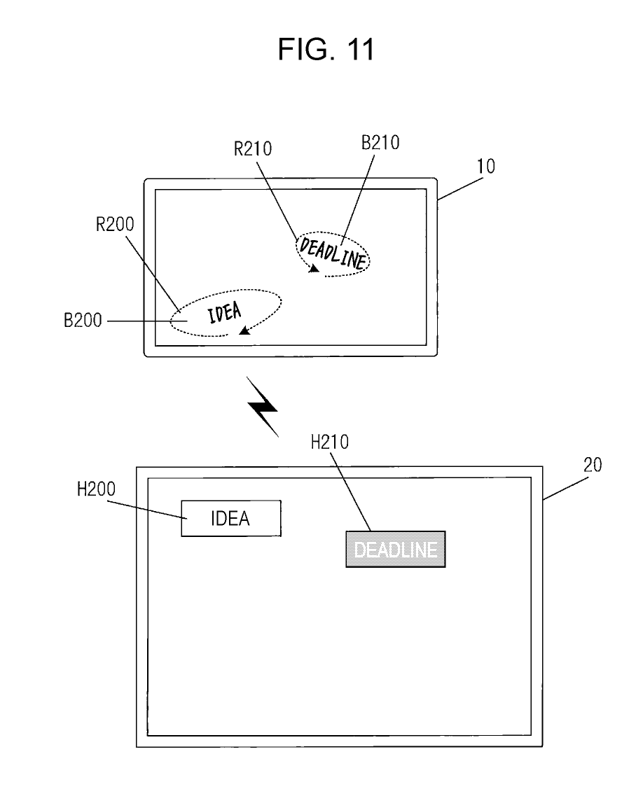

An example of an operation in the fourth embodiment illustrated in FIG. 11, for instance. A handwritten character string B200 and a handwritten character string B210 are displayed on the terminal device 10. An enclosed region R200 is selected in a clockwise manner for the handwritten character string B200 and an enclosed region R210 is selected in a counterclockwise manner for the handwritten character string B210.

Herein, label data selected by the enclosed regions and converted is displayed on the display device 20. The label data H200 and the label data H210 having different attributes are displayed in different manners.

According to the embodiment, the display device may display the label data while changing the display mode of label data in accordance with the attribute of the label data that is added in accordance with a manner of selecting an enclosed region in a label selection input.

[5. Fifth Embodiment]

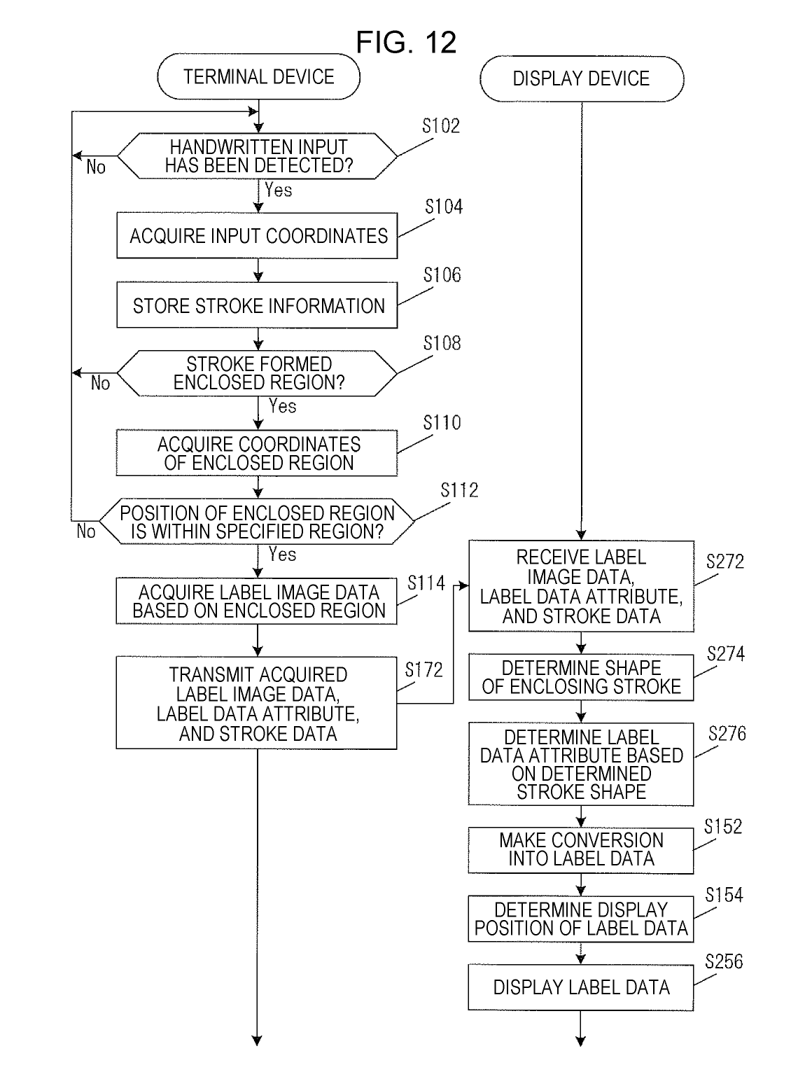

A fifth embodiment is an embodiment in which the display device 20 determines the label data attribute in the embodiment described above. For instance, the fifth embodiment, which is applied to the second embodiment, is an embodiment in which a processing flow in FIG. 9 is replaced by FIG. 12. Though the flow of processing in the embodiment will be described based on FIG. 12, the same processing is provided with the same reference characters and description thereon is omitted.

That is, in the embodiment, stroke data itself used in acquisition of the label image data is transmitted to the display device 20 (step S172). The display device 20 receives the stroke data together with the label image data and the label data attribute (step S272).

Then, a shape of an enclosing stroke is determined based on the stroke data (step S274) and the attribute of the label data is determined based on the determined stroke shape (step S276).

Herein, in determination of the attribute, the attribute is determined based on the stroke data, other inputted information, and the like. For instance, information on the shape of the region, information as to whether the stroke was drawn clockwise or counterclockwise when the enclosed region was drawn, information on the number of fingers or pens for drawing of the stroke, information as to whether the enclosed region was inputted with another operation or not, and the like are transmitted from the terminal device 10 to the display device 20. The display device 20 determines the attribute of the label data based on those pieces of information. The attribute may be determined based on a piece of information or combination of a plurality of pieces of information.

According to the embodiment, the determination of the attribute of the label data may be made not by the terminal device 10 but by the display device 20. For the other embodiments, it is a matter of course that the display device 20 may determine the attribute of the label data likewise.

[6. Sixth Embodiment]

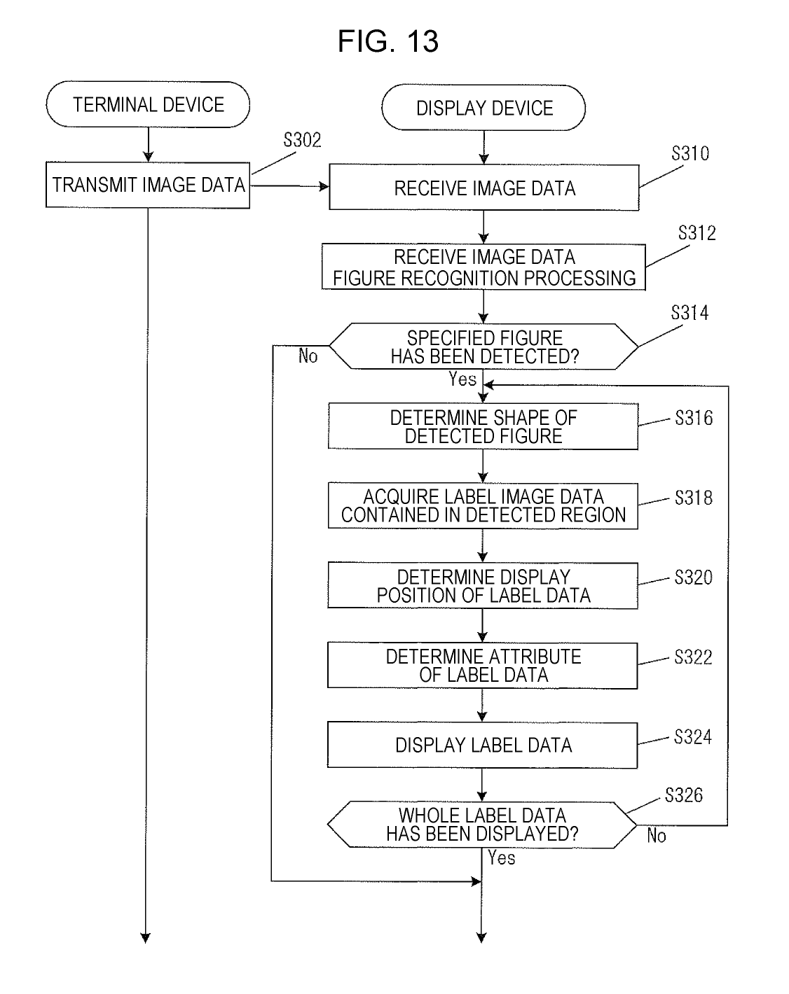

A sixth embodiment is an embodiment in which label data is recognized all on a side of the display device 20. In the embodiment, a processing flow illustrated in FIG. 5 for the first embodiment is replaced by a processing flow of FIG. 13. The flow of processing in the embodiment will be described based on FIG. 13.

An image containing figures is displayed on the terminal device 10. Figures to be made into label data are selected from the image by an enclosed region and image data thereof is transmitted to the display device 20 (step S302).

When the display device 20 receives the image data (step S310), the display device 20 carries out figure recognition processing for the received image data (step S312) so as to acquire figures from the image.

Various methods are conceivable as a method of acquiring the figures from the image. In cases where the stroke information is transmitted together with the image data, the figures are recognized with reference to the stroke information. In cases where the image is vector data, the figures are recognized with reference to the vector data. In cases where the image is raster data, the figures are recognized based on shapes of the figures.

If specified figure data is detected in the recognized figures, a shape of the detected figure is determined. (step S314; Yes→step S316). For instance, a shape of the enclosed region is detected or, when other figures are contained in the enclosed region, shapes of the figures are detected. It is then determined that the detected shape is a label selection input and figures contained in the detected region are acquired as label image data (step S318).

The label image data is converted into the label data and a display position of the label data is determined (step S320). Then an. attribute of the label data is determined (step S322). The label data is displayed based on the converted label data and the display position and the attribute of the label data (step S324).

If the whole of the label data contained in the image has not been displayed, the processing is iteratively carried out (step S326; No→step S316). If the whole of the label data has been displayed, the processing is ended (step S326; Yes).

According to the embodiment, collective transmission of the image from the terminal device 10 thus makes it possible to display desired label data on the display device 20. Therefore, the label image data does not have to be transmitted iteratively and communication traffic between the terminal device 10 and the display device 20 can be reduced. Besides, an effect of collective processing is expected, providing that the display device 20 has higher processing capability than the terminal device 10 has.

[7. Seventh Embodiment]

A seventh embodiment, will be described. In the seventh embodiment, when label image data is transmitted from the terminal device 10, information the terminal device 10 retains may be transmitted. The display device 20 displays label data while changing the display modes based on information from the terminal device 10.

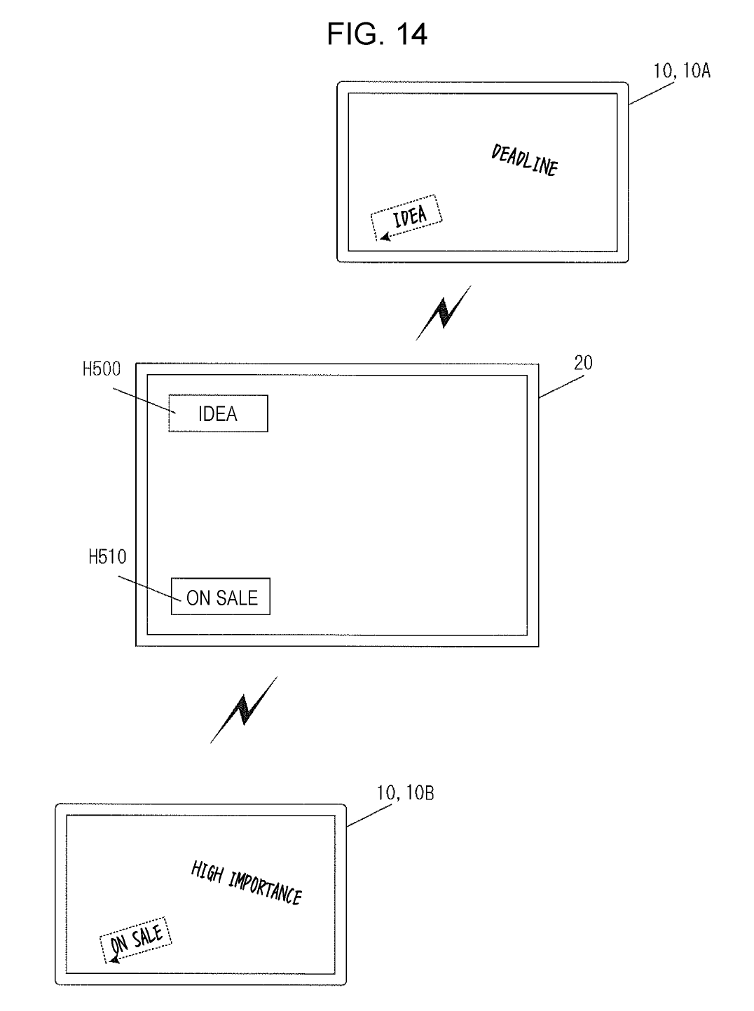

For instance, FIG. 14 illustrates a whole system of the embodiment. In FIG. 14, as the terminal devices 10, a terminal device 10A and a terminal device 10B are connected to the display device 20. Various types of information may be stored in these terminal devices 10. As the information the terminal device 10 retains, for instance, various types of information including configuration information such as IP address and identity specific to the terminal device and user information such as login name (user name) and user name inputted by handwriting may be stored. The environmental information may be one of those pieces of information or may be combination of a plurality of pieces of information. The configuration information and the user information will be collectively referred to as environmental information for the terminal device 10 and will be described below.

The environmental information stored in the terminal device 10 is transmitted to the display device 20 in step S116 in the first embodiment.

Herein, the environmental information may be information stored in advance or information set and stored by the user. The environmental information may also be information set as factory default such as terminal-specific information (production identifying information, MAC address, and the like of the terminal).

Other than login information, there may be user information (user name) bound to figures inputted by handwriting. The user information may be login information for the terminal or information bound to an input device (a touch pen or the like, for instance).

Transmission of such environmental information to the display device 20 makes it possible to change such attributes as color, size, and transmittance of a label in step S152 based on information, such as the environmental information, the terminal device 10 retains. The label data is thereby displayed in a changed display mode of the label data.

The display device 20 may change the region (position) for display. For instance, label data H500 as an object received from the terminal device 10A is displayed in an upper left portion based on the figure, the attribute, and the environmental information. Label data H510 as an object received from the terminal device 10B is displayed in a lower left portion based on the figure, the attribute, and the environmental information.

A direction of display may be changed. If the display device 20 is a table type display, for instance, display may be made in a direction toward the user of the terminal device 10 (for instance, such that a lower side of the label data is directed toward a side on which the terminal device 10 is provided).

Thus the embodiment is a particularly effective embodiment if a plurality of terminal devices 10 are connected to the display device 20. Particularly in late years, it may be considered that the terminal device 10 owned by an individual such as a smartphone or a tablet may be used as the terminal device 10. Even in such cases, it becomes possible for the display device to display appropriate label data, which is displayed while the display modes including display positions and display directions are each changed.

[8. Eighth Embodiment]

An eighth embodiment will be described. In the eighth embodiment, a display mode on the display device 20 may be changed based on attribute information, the environmental information, and/or the like transmitted with the label image data in the seventh embodiment.

In the display device 20, specifically display may be selected or the environmental information may be displayed (the user name may be displayed together with the label data, for instance) based on the attribute. For instance, the user name may be displayed together with the label data or the IP address, machine name, or the like of the terminal that has been transmitted may be displayed.

Switching of validity/invalidity of the attributes and switching of display/nondisplay of the environmental information can be carried out in the display device 20.

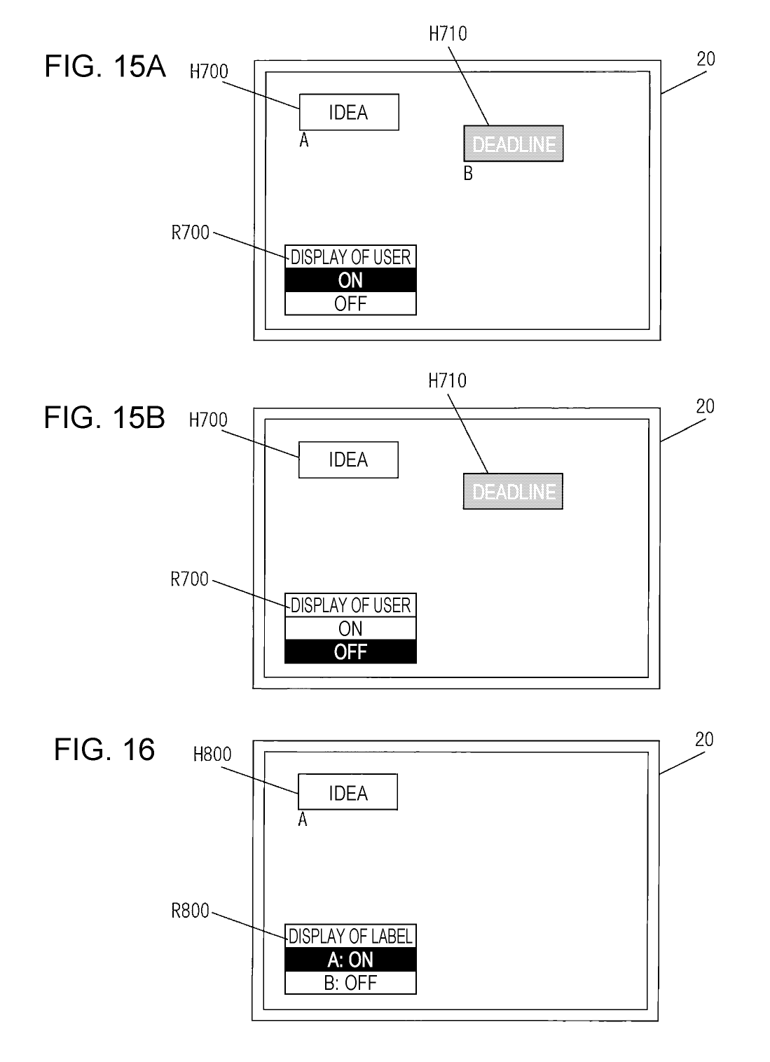

An example of an operation in the embodiment is illustrated in FIGS. 15A and 15B. FIG. 15A is a diagram illustrating the display device 20 in which the environmental information has been turned “ON”. Display of user has been set “ON” by a region R700, for instance.

In this case, a user name “A” is displayed adjacent to label data H700. Besides, a user name “B” is displayed adjacent to label data H710.

In FIG. 15B, the display of user has been set “OFF” by a selecting operation on the region R700. In FIG. 15B, any user name is not displayed adjacent to the label data H700 and the label data H710.

According to the embodiment, the display/nondisplay of the environmental information thus can be effected on the display device 20. The switching of the display/nondisplay of the environmental information may be carried out on the terminal device 10. The display/nondisplay may be switched as general setting or may be switched for each label data, for instance. The display/nondisplay may be switched in accordance with the shape of the enclosed region.

In the embodiment described above, whether the environmental information is displayed in the label data is described. However, the display/nondisplay of the label data itself may be switched. That is, the label data of only, a specified user may be displayed or may not be displayed.

[9. Ninth Embodiment]

A ninth embodiment will be described. In the ninth embodiment, the display/nondisplay of label data may be switched with use of the environmental information or the attributes.

For instance, attributes or the environmental information are stored for each label data. Therefore, label data to be displayed can collectively be selected so as to be displayed or so as not to be displayed by the user.

An example of an operation in the embodiment is illustrated in FIG. 16. In FIG. 16, label data to be displayed is selected in an enclosed region R800. Specifically, selection has been made so that the label data for a user A may be displayed and so that the label data for a user B may not be displayed.

In this example, compared with FIG. 16A, for instance, label data H800 for which the user A is stored as the environmental information is displayed and label data for which the user B is stored as the environmental information is not displayed.

Though the above embodiment has been described with use of the environmental information as an example, the display/nondisplay may be switched with designation of an attribute, such as color and shape, of the label data. The switching of the display/nondisplay may be carried out from the terminal device 10.

Further, a plurality of items of the environmental information and/or the attributes may be combined. For instance, the display/nondisplay may be switched with use of combined conditions such as label data for Mr. A and of high importance and label data for Ms. B and in red.

[10. Tenth Embodiment]

A tenth embodiment will be described. The tenth embodiment in which timing of transmission of the label data is additionally different in the embodiments described above will be described.

In the embodiments described above (the first embodiment, for instance), the operation of enclosing an object triggers off the transmission of the label image data. The object (the figure, for instance), however, may be identified by continuation of an inactive state for a given period of time after entry and the identified figure may be transmitted as the label data.

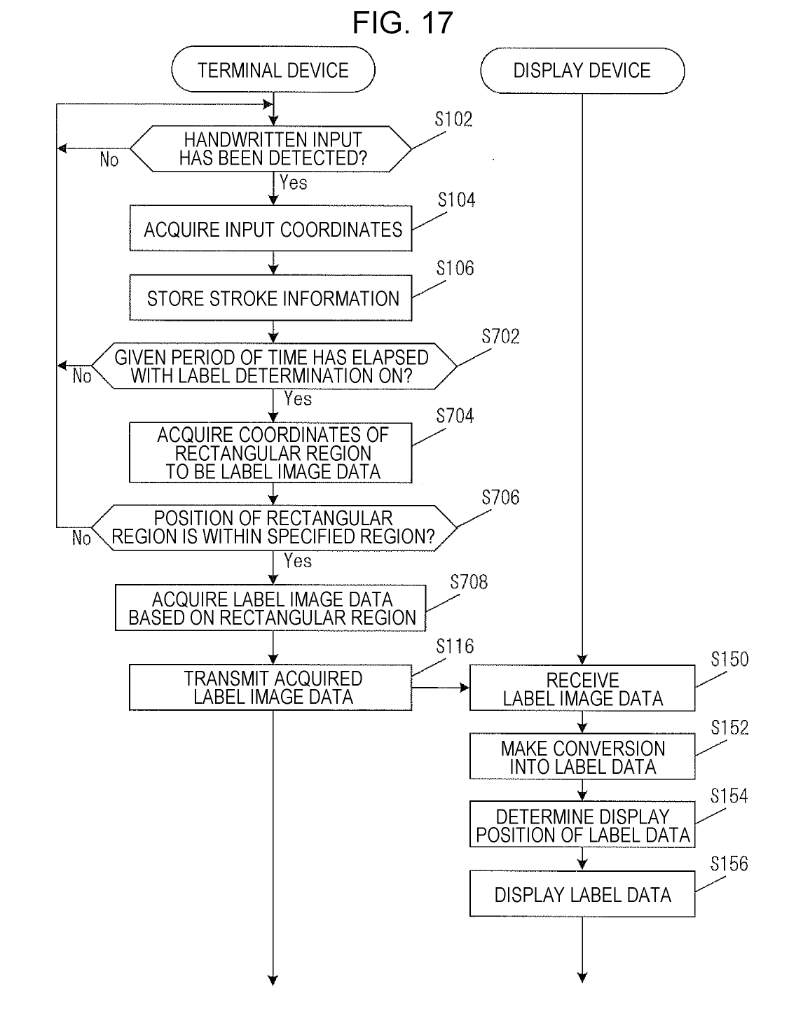

In this case, a region into which data inputted after last timing of the continuation of the inactive state for the given period of time is fitted is clipped as a rectangular region and is transmitted as the label data. Processing in the embodiment will be described with use of FIG. 17. In FIG. 17, substitution is made for the processing flow of FIG. 5. Therefore, the same processing as that of FIG. 5 is provided with the same reference characters and description thereon is omitted.

It is determined whether the given period of time has elapsed or not since storage of the stroke information (step S702). If the given period of time has elapsed, coordinates of the rectangular region that are to be the label image data are acquired (step S704). If a position of the rectangular region is within a specified region (step S706; Yes), the label image data is acquired based on the rectangular region (step S708).

In the example of FIGS. 6A and 6B, for instance, the inactive state may be made to continue for the given period of time after handwriting of the characters “IDEA” and the rectangular region may consequently be clipped so that a part where the characters “IDEA” are written may be fitted into the rectangular region. In clipping of the rectangular region, the rectangular region into which the handwriting is fitted may be clipped or angles of the rectangular region to be clipped may be subjected to adjustment or the like in consideration of an inclination of the handwritten characters. The data equivalent to the rectangle R100 may be generated by the adjustment of the rectangular region.

Description will be given on label determination ON in step S702. It is desirable to make a distinction between ordinary handwritten input and input of the label data and thus such an operation as a change in input mode may be carried out between the ordinary handwritten input and the input of the label data. The label determination is turned ON in cases of the input mode for the label data being “ON”, a handwritten input after selection of pen mode for the input of the label data, or the like. In case where the label determination is ON, the label image data is acquired.

Specifically, a mode (handwritten input mode) for the ordinary handwritten input and a mode (label data input mode) for handwritten input that can be converted into the label data can be selected. Upon selection of the label data input mode and performance of a handwritten input, the processing in the embodiment is carried out. That is, a conversion into the label data (label image data) is made after a lapse of the specified period of time after the handwritten input. A handwritten input performed in the handwritten input mode that is an ordinary input mode is not converted into the label data (label image data) even after the lapse of the specified period of time. The conversion into the label data is made on condition that the label data input mode has been selected as a specified input mode, for instance.

As described for the first embodiment, for instance, the conversion into the label data (label image data) is made when an inputted figure is enclosed (when the enclosed region is formed by a stroke). In the embodiment as well, an operation of enclosing an inputted figure may be made an operation that causes the conversion into the label data before the lapse of the specified period of time.

The label determination may be turned ON by switching to the mode for the input of the label data or by a mode ON switch or the like. It may be determined that the label determination is ON, in cases where a specified operation (such as an operation with a button on a pen being pressed, a handwritten input with a touch by one hand, and an operation using two fingers) is carried out.

Depending on a system, all of input in a specified region may be determined as the label image data or all of handwritten input may be converted into the label image data.

Though the above embodiment has been described with use of the “rectangular region”, the region has only to be an enclosed region (closed region) and may have various shapes such as circular, elliptical, triangular, and trapezoidal shapes. The user may set a shape of the region.

[11. Modifications]

The disclosure is not limited to the embodiments described above but may be modified in various manners. That is, embodiments obtained by combination of technical devices appropriately modified within a scope not departing from the purport of the disclosure are included in the technical scope of the disclosure.

Furthermore, the label image data may be transmitted to The display device 20 by e-mail or the label image data transmitted (uploaded) to a cloud service may be displayed by the display device 20. Moreover, selected label data may be saved in a recording medium and the saved label data may be displayed by the display device 20.

Though the terminal device and the display device as the image display devices have been described for the embodiments, the devices may be configured as one device. It is a matter of course that the terminal device and the display device may be connected via cloud.

In use of cloud, the label image data may be transmitted from the terminal device through a cloud server to the display device. A part of the processing in the terminal device and the display device may be carried out by the cloud server.

The above functions may each be configured as programs or as hardware. In cases where the functions are implemented as programs, the programs recorded in a recording medium may be read out from the recording medium in order to be executed or the programs saved in a network may be downloaded in order to be executed.

Though the description on the above embodiments has been given with use of the touch panel as the touch detection unit and with use of the touch operation (tapping operation) as the operation as an example, the operation may be carried out by a click operation or the like on an external input device such as a mouse, for instance.

Though the examples in which the display device includes the display unit and the operational input unit have been described for the above embodiments, it is a matter of course that another scheme may be used in order that the disclosure disclosed in the embodiments may be implemented. For instance, a projector may be used as the display unit 210 and a person detecting sensor may be used as the operational input unit 220. A display system. may be implemented by connection of a computer for control to the operational input unit 220 and tine display unit 210.

Though some portions of the above embodiments have been described separately for convenience, it is a matter of course that the portions may be carried out in combination within a technically feasible scope.

Thus the embodiments described herein may be carried out in combination as long as any conflict is not caused therein.

In the embodiments, as described above, a region is identified by being selected. Herein, methods of identifying a region include various methods such as input and determination, other than the selection.

The programs operating in the devices in the embodiments are programs that control the CPUs and the like (programs that make computers function) so as to implement the functions of the embodiments described above. The information that is handled in the devices is temporarily accumulated in a temporary storage (such as RAM) during processing thereof, thereafter stored in a storage such as ROM, HDD, and SSD, and read out for modification and/or writing by the CPU as appropriate.

For distribution to market, the programs may be stored in portable recording media to be distributed and/or may be transferred to server computers connected through networks such as the Internet. It is a matter of course that storages for the server computers are encompassed by the disclosure.

The functions may be implemented by installing applications including the functions in various devices such as a smartphone, a tablet, and an image forming device and executing the applications.

The present disclosure contains subject matter related to that disclosed in Japanese Priority Patient Application JP 2017-20647 filed in the Japan Patent Office on Oct. 25, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display system comprising:
a terminal device; and
a display device connected to the terminal device, wherein
the terminal device includes
a region identification unit that identifies a partial region of a display screen,
an acquisition unit that acquires one or more objects which are figures and/or characters contained in the identified region,
an attribute determination unit that determines an attribute of the acquired objects which is used when the objects are displayed, and
a transmission unit that transmits the objects and the attribute of the objects to the display device, and the display device includes
a reception. unit that receives the objects and the attribute of the objects from the terminal device, and
a display unit that determines display positions of the received objects, determines a display mode based on the attribute of the received objects, and displays the received objects in the display positions in the display mode.

2. The display system according to claim 1, wherein the attribute of the objects is determined based on at least any one of information on a shape of a region, information as to whether a stroke was drawn clockwise or counterclockwise when an enclosed region was drawn, information on a number of fingers or pens for drawing of the stroke, and information as to whether the enclosed region was inputted with another operation or not.

3. The display system according to claim 1, wherein
the reception unit further receives environmental information from the terminal device, and
the display unit determines the display mode based on the attribute of the objects and the environmental information.

4. The display system according to claim 3, wherein the environmental information is at least any one of information on a user and identity of the terminal device.

5. display system according to claim 3, wherein the display unit is capable of displaying the environmental information together with the objects.

6. The display system according to claim 3, wherein the display unit switches display/nondisplay of the objects based on the environmental information.

7. A display device connectable to a terminal device, the display device comprising:
a reception unit that receives image data from the terminal device;
an acquisition. unit that acquires one or more objects which are figures and/or characters from the image data;
an attribute determination unit that determines an attribute of the acquired objects which is used when the objects are displayed; and
a display unit that determines display positions of the acquired objects, determines a display mode based on the determined attribute of the objects, and displays the objects in the display positions in the display mode.

8. A terminal device connected to a display device that displays objects in a display mode based on an attribute of the objects, the terminal device comprising:
a region identification unit that identifies a partial region of a display screen;
an acquisition unit that acquires one or more objects which are figures and/or characters contained in the identified region;
an attribute determination unit that determines the attribute of the acquired objects which. is used when the objects are displayed; and
a transmission unit that transmits the objects and the attribute of the objects to the display device.

9. A non-transitory recording medium that stores a program causing a computer connectable to a terminal device to implement:
a reception function of receiving image data from the terminal device;
an acquisition function of acquiring one or more objects that are figures and/or characters from the image data;
an attribute determination function of determining an attribute of the acquired objects which is used when the objects are displayed; and
a display function of determining di pi positions of the acquired objects, determining a display mode based on the determined attribute of the objects, and displaying the objects in the display positions in the display mode.
